(19) United States
(12) Patent Application Publication
(10) Pub. No.: US 2023/0134710 A1
(43) Pub. Date: May 4, 2023

(54) ELECTRONIC CONTROL DEVICE AND POWER SUPPLY INPUT CIRCUIT

(71) Applicant: Mitsubishi Electric Corporation, Tokyo (JP)

(72) Inventors: Masanori IKEUCHI, Tokyo (JP); Takamasa ASAI, Tokyo (JP)

(73) Assignee: Mitsubishi Electric Corporation, Tokyo (JP)

(21) Appl. No.: 17/967,171

(22) Filed: Oct. 17, 2022

(30) Foreign Application Priority Data
Oct. 28, 2021 (JP) 2021-176006

(51) Int. Cl. H02H 7/20

(52) U.S. Cl. CPC H02H 7/20

(57) ABSTRACT

An electronic control device includes a plurality of circuit blocks and a power supply input circuit. The power supply input circuit supplies power supplied from a first external power supply to the plurality of circuit blocks. The power supply input circuit includes a power supply input terminal, a power supply input line, a plurality of branching lines, a first reverse-current preventing element, and a second reverse-current preventing element. The plurality of branching lines are each connected between a second end portion of the power supply input line and a corresponding one of the plurality of circuit blocks. The first reverse-current preventing element is provided on the power supply input line. The second reverse-current preventing element is provided on the first branching line. The first branching line is connected to the first circuit block.

### BACKGROUND OF THE INVENTION

### 1. Field of the Invention

This disclosure relates to an electronic control device and a power supply input circuit.

### 2. Description of the Related Art

In a related-art on-vehicle electronic control device, in some cases, a reverse-current interrupting element remains closed even when a voltage of an on-vehicle battery serving as an external power supply is momentarily reduced. Accordingly, in order to prevent an output voltage of the reverse-current interrupting element from being reduced together with the voltage of the on-vehicle battery when the voltage of the on-vehicle battery is momentarily reduced, a capacitor is connected to an output side of the reverse-current interrupting element (see, for example, Japanese Patent Application Laid-open No. 2015-140094).

In the related-art on-vehicle electronic control device described above, in order to maintain the output voltage of the reverse-current interrupting element until the reduced voltage of the on-vehicle battery is recovered to a normal voltage, the capacitor on the output side of the reverse-current interrupting element is required to be a large-capacitance capacitor. Accordingly, there has been a problem in that the capacitor on the output side of the reverse-current interrupting element is increased in size, and as a result, the device is increased in size.

### SUMMARY OF THE INVENTION

This disclosure has been made in order to solve the above-mentioned problem, and has an object to provide an electronic control device and a power supply input circuit with which an increase in size of the electronic control device can be suppressed.

According to at least one embodiment of this disclosure, there is provided an electronic control device including: a plurality of circuit blocks; and a power supply input circuit configured to supply power supplied from an external power supply to the plurality of circuit blocks, wherein the plurality of circuit blocks include a first-type block and a second-type block, and wherein the power supply input circuit includes: a power supply input terminal to be connected to the external power supply; a power supply input line including a first end portion connected to the power supply input terminal, and a second end portion being an end portion on an opposite side of the first end portion; a plurality of branching lines connected between the second end portion and each of the plurality of circuit blocks; a first reverse-current preventing element which is provided on the power supply input line, and is configured to prevent a reverse current from flowing; and a second reverse-current preventing element which is provided on one of the plurality of branching lines that is connected to the first-type block, and is configured to prevent a reverse current from flowing.

According to the electronic control device and the power supply input circuit of the at least one embodiment of this disclosure, an increase in size of the electronic control device can be suppressed.

### BRIEF DESCRIPTION OF THE DRAWINGS

FIG. 1 is a configuration diagram for illustrating an electronic control device according to a first embodiment of this disclosure.

FIG. 2 is a configuration diagram for illustrating an electronic control device serving as a comparative example.

FIG. 3 is a timing chart for illustrating an operation of a power supply input circuit of FIG. 1 and an operation of a power supply input circuit of FIG. 2.

FIG. 4 is a configuration diagram for illustrating an electronic control device according to a second embodiment of this disclosure.

FIG. 5 is a configuration diagram for illustrating an electronic control device according to a third embodiment of this disclosure.

### DESCRIPTION OF THE EMBODIMENTS

Now, embodiments of this disclosure are described with reference to the drawings.

### First Embodiment

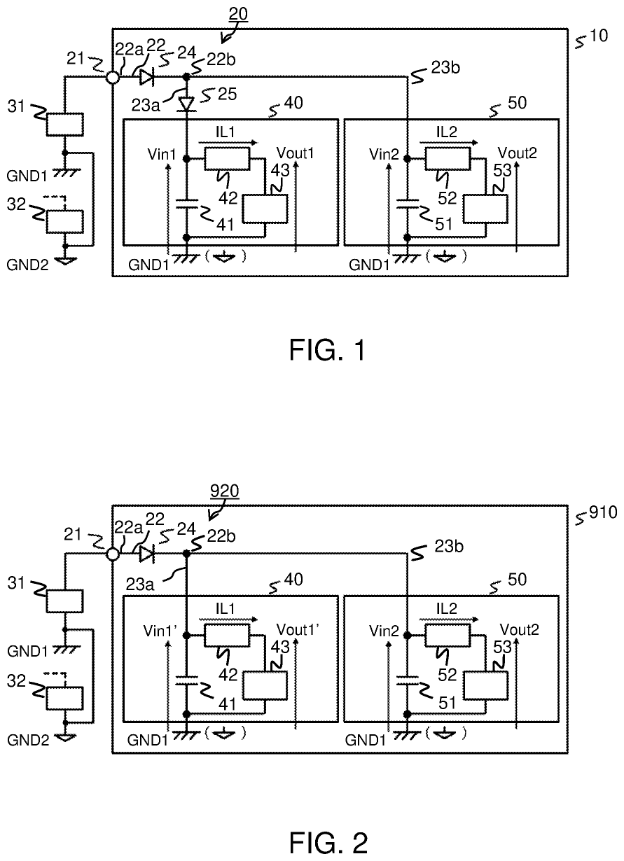

FIG. 1 is a configuration diagram for illustrating an electronic control device according to a first embodiment of this disclosure. In the first embodiment, an electronic control device 10 is an on-vehicle electronic control device. The electronic control device 10 includes a power supply input circuit 20 and a plurality of circuit blocks. The plurality of circuit blocks include a first circuit block 40 serving as a first-type block, and a second circuit block 50 serving as a second-type block.

The second circuit block 50 is one of the plurality of circuit blocks. Further, among the plurality of circuit blocks, a circuit block excluding the second circuit block 50 is the first-type block, that is, the first circuit block 40. In the first embodiment, the number of the first-type blocks is one, and the number of the second-type blocks is one.

The power supply input circuit 20 includes a power supply input terminal 21, a power supply input line 22, a first branching line 23a, a second branching line 23b, a first reverse-current preventing element 24, and a second reverse-current preventing element 25. The power supply input circuit 20 supplies power supplied from a first external power supply 31 serving as an external power supply to the first circuit block 40 and the second circuit block 50.

The power supply input terminal 21 is connected to a positive terminal of the first external power supply 31. In the first embodiment, an on-vehicle battery is used as the first external power supply 31. A negative terminal of the first external power supply 31 is connected to a first ground GND1. The first ground GND1 is a ground inside of the electronic control device 10. A second external power supply 32 supplies power to another device different from the electronic control device 10. A negative terminal of the second external power supply 32 is connected to a second ground GND2. The second ground GND2 is connected to the first ground GND1 at the outside of the electronic control device 10.

The power supply input line 22 includes a first end portion 22a and a second end portion 22b. The first end portion 22a is electrically connected to the power supply input terminal 21. The second end portion 22b is an end portion on the opposite side of the first end portion 22a.

The first branching line 23a is electrically connected between the second end portion 22b and the first circuit block 40. The second branching line 23b is electrically connected between the second end portion 22b and the second circuit block 50. The first branching line 23a and the second branching line 23b form a plurality of branching lines.

The first reverse-current preventing element 24 is provided on the power supply input line 22. The first reverse-current preventing element 24 prevents a reverse current from flowing. In other words, the first reverse-current preventing element 24 causes a current to flow in a forward direction, and prevents a current from flowing in a reverse direction. In the following, a portion into which the current in the forward direction flows is referred to as “input portion of the first reverse-current preventing element 24,” and a portion from which the current in the forward direction flows out is referred to as “output portion of the first reverse-current preventing element 24.”

The input portion of the first reverse-current preventing element 24 is electrically connected to the first end portion 22a, and the output portion of the first reverse-current preventing element 24 is electrically connected to the second end portion 22b. As the first reverse-current preventing element 24, for example, a diode is used. In this case, the input portion of the first reverse-current preventing element 24 is an anode, and the output portion of the first reverse-current preventing element 24 is a cathode.

The second reverse-current preventing element 25 is provided on the first branching line 23a. The second reverse-current preventing element 25 prevents a reverse current from flowing. In other words, the second reverse-current preventing element 25 causes a current to flow in a forward direction, and prevents a current from flowing in a reverse direction. In the following, a portion into which the current in the forward direction flows is referred to as “input portion of the second reverse-current preventing element 25,” and a portion from which the current in the forward direction flows out is referred to as “output portion of the second reverse-current preventing element 25.”

The input portion of the second reverse-current preventing element 25 is electrically connected to the second end portion 22b, and the output portion of the second reverse-current preventing element 25 is electrically connected to the first circuit block 40. As the second reverse-current preventing element 25, for example, a diode is used. In this case, the input portion of the second reverse-current preventing element 25 is an anode, and the output portion of the second reverse-current preventing element 25 is a cathode.

The first circuit block 40 includes a first input capacitor 41, a first internal power supply 42 serving as a first-type internal power supply, and a first load 43. The first input capacitor 41 is connected between the first branching line 23a and the first ground GND1. That is, the first input capacitor 41 is electrically connected to the output portion of the second reverse-current preventing element 25. The first internal power supply 42 and the first load 43 are connected in series to each other between the first branching line 23a and the first ground GND1. That is, the first input capacitor 41 is connected in parallel to the first internal power supply 42 and the first load 43.

An input portion of the first load 43 is connected to an output portion of the first internal power supply 42. An output portion of the first load 43 is connected to the first ground GND1.

The first internal power supply 42 generates a first output voltage Vout1 through use of power supplied from the first external power supply 31. A first load current IL1 flows through the first circuit block 40.

The second circuit block 50 includes a second input capacitor 51, a second internal power supply 52 serving as a second-type internal power supply, and a second load 53. The second input capacitor 51 is connected between the second branching line 23b and the first ground GND1. The second internal power supply 52 and the second load 53 are connected in series to each other between the second branching line 23b and the first ground GND1. That is, the second input capacitor 51 is connected in parallel to the second internal power supply 52 and the second load 53.

An input portion of the second load 53 is connected to an output portion of the second internal power supply 52. An output portion of the second load 53 is connected to the first ground GND1.

The second internal power supply 52 generates a second output voltage Vout2 through use of power supplied from the first external power supply 31. A second load current IL2 flows through the second circuit block 50. The second load current IL2 is larger than the first load current IL1.

Further, in the first embodiment, a lower limit value Vmin2 of an operating voltage of the second internal power supply 52 is lower than a lower limit value Vmin1 of an operating voltage of the first internal power supply 42. The operating voltage is an input voltage that allows the internal power supply to generate a normal output voltage.

FIG. 2 is a configuration diagram for illustrating an electronic control device serving as a comparative example. An electronic control device 910 of FIG. 2 includes a power supply input circuit 920, the first circuit block 40, and the second circuit block 50.

The power supply input circuit 920 is different from the power supply input circuit 20 of FIG. 1 only in not including the second reverse-current preventing element 25 of FIG. 1. Accordingly, the electronic control device 910 is different from the electronic control device 10 of FIG. 1 only in that the power supply input circuit 920 does not include the second reverse-current preventing element.

Further, in the electronic control device 910 of FIG. 2, similarly to the electronic control device 10 of FIG. 1, the second load current IL2 is larger than the first load current IL1.

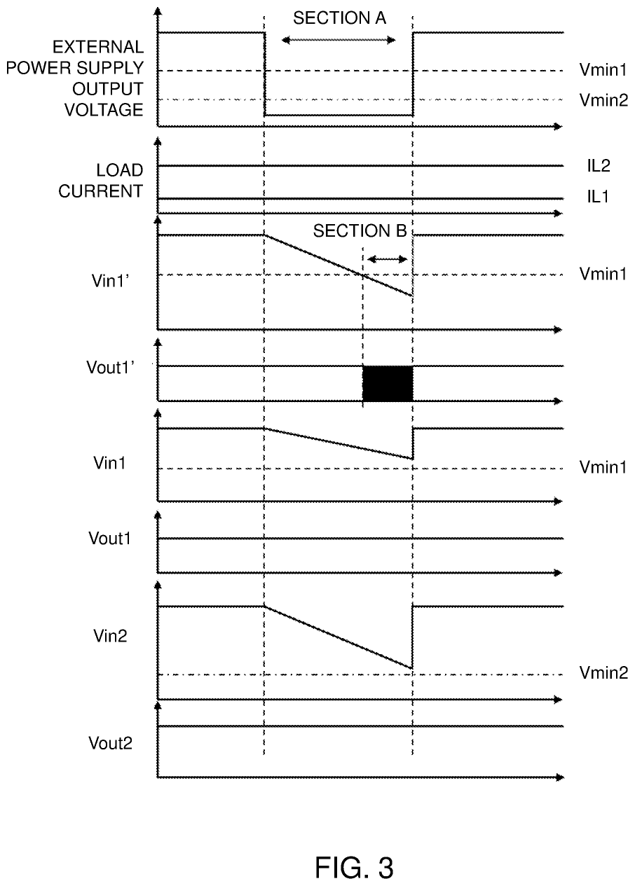

FIG. 3 is a timing chart for illustrating an operation of the power supply input circuit 20 of FIG. 1 and an operation of the power supply input circuit 920 of FIG. 2.

In FIG. 3, a section A is a section in which the output voltage of the first external power supply 31 is momentarily reduced. A length of the section A is a length of time for which, even when the output voltage of the first external power supply 31 is momentarily reduced, a continuous normal operation of the electronic control device 10 is required to be ensured. In other words, during a period of the section A, regardless of the output voltage of the first external power supply 31, the electronic control device 10 is required to be normally operated continuously. That is, during the period of the section A, the first internal power supply 42 and the second internal power supply 52 are required to continuously output normal voltages.

In this case, in the section A, a slope in which a voltage Vin1′ across both ends of the first input capacitor 41 of FIG. 2 is reduced and a slope in which a voltage Vin2 across both ends of the second input capacitor 51 of FIG. 2 is reduced are equal to each other.

The voltage Vin1′ across both ends of the first input capacitor 41 of FIG. 2 is reduced due to discharge via the first load 43 and discharge via the second load 53. When the second load current IL2 is sufficiently larger than the first load current IL1, the discharge via the second load 53 is dominant over the discharge via the first load 43 in the degree of influence to the slope in which the voltage Vin1′ across both ends of the first input capacitor 41 of FIG. 2 is reduced.

When the reduced voltage Vin2 across both ends of the second input capacitor 51 is equal to or larger than the lower limit value Vmin2 of the operating voltage of the second internal power supply 52, the output voltage Vout2 of the second internal power supply 52 is continuously output as a normal voltage.

Further, in FIG. 3, a section B is a section in which the voltage Vin1′ across both ends of the first input capacitor 41 of FIG. 2 is lower than the lower limit value Vmin1 of the operating voltage of the first internal power supply 42.

Thus, in the section B, an output voltage Vout1′ of the first internal power supply 42 of FIG. 2 does not become a normal value. Accordingly, in general, in order to prevent the voltage Vin1′ across both ends of the first input capacitor 41 of FIG. 2 from becoming lower than the lower limit value Vmin1 of the operating voltage of the first internal power supply 42, an electrostatic capacitance of the first input capacitor 41 is increased. However, when the electrostatic capacitance of the first input capacitor 41 is increased, a mounting area of the device is occupied, and a component cost is increased.

In view of the above, in the power supply input circuit 20 of FIG. 1, when the output voltage of the first external power supply 31 is momentarily reduced, the second reverse-current preventing element 25 prevents a sneak current from flowing from the first input capacitor 41 to the second internal power supply 52. Further, in this case, the first reverse-current preventing element 24 prevents a sneak current from flowing from the second input capacitor 51 to the first external power supply 31.

That is, when the output voltage of the first external power supply 31 is momentarily reduced, charges of the first input capacitor 41 are discharged to the first ground GND1 via the first internal power supply 42 and the first load 43. Further, at this time, charges of the second input capacitor 51 are discharged to the first ground GND1 via the second internal power supply 52 and the second load 53.

When a current is interrupted by the second reverse-current preventing element 25, a sneak current is prevented from flowing from the first input capacitor 41 to the second internal power supply 52. That is, outflow of charges to the outside of the first circuit block 40 is suppressed. As a result, when the output voltage of the first external power supply 31 is momentarily reduced, the discharge via the first load 43 becomes dominant in the degree of influence to the slope of voltage reduction of a voltage Vin1 across both ends of the first input capacitor 41. Thus, the first output voltage Vout1 of the first internal power supply 42 is maintained to a normal value.

Accordingly, an amount of charges of the first input capacitor 41 required for maintaining the operating voltage of the first internal power supply 42 when the output voltage of the first external power supply 31 is momentarily reduced can be reduced. Thus, a capacitor having a smaller electrostatic capacitance can be used as the first input capacitor 41.

As described above, the electronic control device 10 according to the first embodiment includes the plurality of circuit blocks and the power supply input circuit 20. The plurality of circuit blocks include the first circuit block 40 serving as the first-type block, and the second circuit block 50 serving as the second-type block. The power supply input circuit 20 includes the power supply input terminal 21, the power supply input line 22, the first branching line 23a, the second branching line 23b, the first reverse-current preventing element 24, and the second reverse-current preventing element 25.

The power supply input terminal 21 is electrically connected to the first external power supply 31. The power supply input line 22 includes the first end portion 22a and the second end portion 22b. The first end portion 22a is electrically connected to the power supply input terminal 21. The second end portion 22b is an end portion on the opposite side of the first end portion 22a. The plurality of branching lines 23a and 23b are electrically connected between the second end portion 22b and each of the plurality of circuit blocks 40 and 50.

The first reverse-current preventing element 24 is provided on the power supply input line 22, and prevents a reverse current from flowing. The second reverse-current preventing element 25 is provided on the first branching line 23a, and prevents a reverse current from flowing. The first branching line 23a is connected to the first circuit block 40, that is, the first-type block.

With this configuration, the second reverse-current preventing element 25 can prevent a sneak current from flowing from the first input capacitor 41 to the second internal power supply 52. Thus, a capacitor having a smaller electrostatic capacitance can be used as the first input capacitor 41, and hence an increase in size of the electronic control device 10 can be suppressed.

Further, the first circuit block 40 serving as the first-type block includes the first internal power supply 42. The first internal power supply 42 generates the first output voltage Vout1 through use of the power supplied from the first external power supply 31. The second circuit block 50 serving as the second-type block includes the second internal power supply 52. The second internal power supply 52 generates the second output voltage Vout2 through use of the power supplied from the first external power supply 31. The lower limit value of the input voltage that allows the second internal power supply 52 to normally generate the second output voltage Vout2 is lower than the lower limit value of the input voltage that allows the first internal power supply 42 to normally generate the first output voltage Vout1.

With this configuration, even when the output voltage of the first external power supply 31 is momentarily reduced, both of the first circuit block 40 and the second circuit block 50 can be more stably operated.

Further, the second load current IL2 being a load current flowing through the second circuit block 50 is larger than the first load current IL1 being a load current flowing through the first circuit block 40.

With this configuration, even when the output voltage of the first external power supply 31 is momentarily reduced, both of the first circuit block 40 and the second circuit block 50 can be more stably operated.

In the first embodiment, the lower limit value of the operating voltage of the second internal power supply 52 is set to be lower than the lower limit value of the operating voltage of the first internal power supply 42, but the lower limit value of the operating voltage of the second internal power supply 52 may be set to be higher than the lower limit value of the operating voltage of the first internal power supply 42. In this case, the first internal power supply 42 is the second-type internal power supply, and the second internal power supply 52 is the first-type internal power supply. The first circuit block 40 is the second-type block, and the second circuit block 50 is the first-type block. In this case, it suffices that the second reverse-current preventing element is provided not on the first branching line 23a, but on the second branching line 23b.

Further, in the first embodiment, the second load current IL2 is larger than the first load current IL1, but the first load current IL1 may be larger than the second load current IL2. In this case, the second circuit block 50 is the first-type block, and the first circuit block 40 is the second-type block. In this case, it suffices that the second reverse-current preventing element is provided not on the first branching line 23a, but on the second branching line 23b.

Further, in the first embodiment, the electronic control device 10 includes two circuit blocks, but the electronic control device 10 may include three or more circuit blocks. In this case, it suffices that, among the plurality of internal power supplies, an internal power supply having the lowest lower limit value of the operating voltage is selected as the second-type internal power supply. In addition, it suffices that circuit blocks each including the first-type internal power supply are set as the first-type blocks, and that the second reverse-current preventing element is provided on each of a plurality of branching lines connected to the first-type blocks.

Further, when the electronic control device 10 includes three or more circuit blocks, it suffices that a circuit block through which the largest load current flows is selected as the second-type block. In addition, it suffices that the second reverse-current preventing element is provided on each of the plurality of branching lines connected to the first-type blocks.

### Second Embodiment

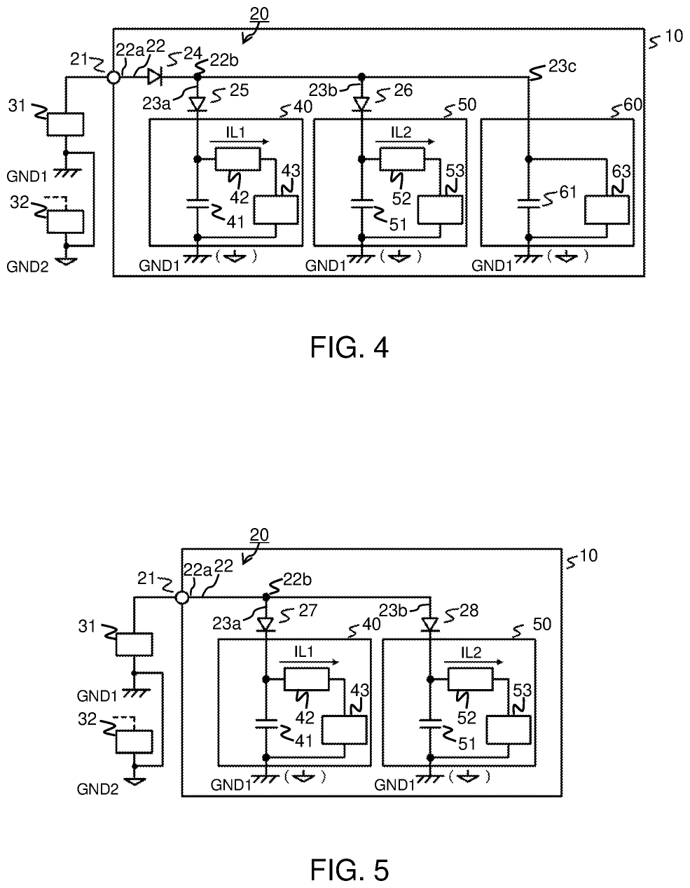

FIG. 4 is a configuration diagram for illustrating an electronic control device according to a second embodiment of this disclosure. In the electronic control device 10 of FIG. 4, a third circuit block 60 is added to the electronic control device 10 of FIG. 1. Further, in the power supply input circuit 20 of FIG. 4, a third branching line 23c is added to the power supply input circuit 20 of FIG. 1, and another second reverse-current preventing element 26 is added to the second branching line 23b. In the second embodiment, the number of the first-type blocks is two, and the number of the second-type blocks is one.

Configurations other than the above-mentioned configurations are similar to those of the electronic control device 10 of FIG. 1. In the following, description of the configurations similar to those of the electronic control device of FIG. 1 is omitted.

The third branching line 23c is connected between the second end portion 22b and the third circuit block 60.

The other second reverse-current preventing element 26 prevents a reverse current from flowing. In other words, the other second reverse-current preventing element 26 causes a current to flow in a forward direction, and prevents a current from flowing in a reverse direction. In the following, a portion into which the current in the forward direction flows is referred to as “input portion of the other second reverse-current preventing element 26,” and a portion from which the current in the forward direction flows out is referred to as “output portion of the other second reverse-current preventing element 26.”

As the other second reverse-current preventing element 26, for example, a diode is used. In this case, the input portion of the other second reverse-current preventing element 26 is an anode, and the output portion of the other second reverse-current preventing element 26 is a cathode.

The third circuit block 60 includes a third input capacitor 61 and a third load 63. The third input capacitor 61 is connected between the third branching line 23c and the first ground GND1. The third load 63 is connected between the third branching line 23c and the first ground GND1. That is, the third input capacitor 61 is connected in parallel to the third load 63.

Accordingly, in the second embodiment, the first circuit block 40 and the second circuit block 50 are each the first-type block, and the third circuit block 60 is the second-type block.

The first circuit block 40 being the first-type block includes the first internal power supply 42 and the first load 43. The second circuit block 50 being the first-type block includes the second internal power supply 52 and the second load 53. The third circuit block 60 being the second-type block includes the third load 63, but does not include an internal power supply.

When the output voltage of the first external power supply 31 is momentarily reduced, the second reverse-current preventing element 25 prevents a sneak current from flowing from the first input capacitor 41 to the second internal power supply 52 and the third load 63. When the output voltage of the first external power supply 31 is momentarily reduced, the other second reverse-current preventing element 26 prevents a sneak current from flowing from the second input capacitor 51 to the first internal power supply 42 and the third load 63.

When the output voltage of the first external power supply 31 is momentarily reduced, the first reverse-current preventing element 24 prevents a sneak current from flowing from the third input capacitor 61 to the first external power supply 31. At this time, the charges of the first input capacitor 41 are discharged to the first ground GND1 via the first load 43 due to the function of the second reverse-current preventing element 25. Further, the charges of the second input capacitor 51 are discharged to the first ground GND1 via the second load 53 due to the function of the other second reverse-current preventing element 26.

As a result, when the output voltage of the first external power supply 31 is momentarily reduced, a current interrupted by the second reverse-current preventing element 25 is prevented from flowing to another circuit block as a sneak current. Accordingly, the discharge via the first load 43 becomes dominant in the degree of influence to the discharge speed of the first input capacitor 41. Further, at this time, a current interrupted by the other second reverse-current preventing element 26 is prevented from flowing to another circuit block as a sneak current. Accordingly, the discharge via the second load 53 becomes dominant in the degree of influence to the discharge speed of the second input capacitor 51.

Thus, when the output voltage of the first external power supply 31 is momentarily reduced, an amount of charges required for the first input capacitor 41 to maintain the operating voltage of the first internal power supply 42 can be reduced. Similarly, when the output voltage of the first external power supply 31 is momentarily reduced, an amount of charges required for the second input capacitor 51 to maintain the operating voltage of the second internal power supply 52 can be reduced.

As described above, according to the electronic control device 10 of the second embodiment, the first-type block includes the first-type internal power supply which generates the output voltage through use of the power supplied from the external power supply 31, and the load connected to the output portion of the first-type internal power supply. Further, the second-type block includes the load, but does not include an internal power supply.

With this configuration, a capacitor having a smaller electrostatic capacitance can be used as each of the first input capacitor 41 and the second input capacitor 51, and hence an increase in size of the electronic control device 10 can be suppressed.

In the second embodiment, the second-type block is the third circuit block 60, but the second-type block may be the first circuit block 40. In this case, it suffices that the second reverse-current preventing element is provided on each of the second branching line 23b and the third branching line 23c.

Further, the second-type block may be the second circuit block 50. In this case, it suffices that the second reverse-current preventing element is provided on each of the first branching line 23a and the third branching line 23c.

Further, in the second embodiment, the electronic control device 10 includes three circuit blocks, but the number of the circuit blocks may be two, or four or more. In this case, it suffices that a circuit block including no internal power supply is set as the second-type block.

### Third Embodiment

FIG. 5 is a configuration diagram for illustrating an electronic control device according to a third embodiment of this disclosure. The electronic control device 10 includes the power supply input circuit 20, the first circuit block 40, and the second circuit block 50.

The power supply input circuit 20 includes the power supply input terminal 21, the power supply input line 22, the first branching line 23a, the second branching line 23b, a reverse-current preventing element 27, and another reverse-current preventing element 28.

The power supply input terminal 21 is connected to the positive terminal of the first external power supply 31 serving as an external power supply. In the third embodiment, an on-vehicle battery is used as the first external power supply 31. The negative terminal of the first external power supply 31 is connected to the first ground GND1. The first ground GND1 is a ground inside of the electronic control device 10. The second external power supply 32 supplies power to another device different from the electronic control device 10. The negative terminal of the second external power supply 32 is connected to the second ground GND2. The second ground GND2 is connected to the first ground GND1 at the outside of the electronic control device 10.

The power supply input line 22 includes the first end portion 22a and the second end portion 22b. The first end portion 22a is electrically connected to the power supply input terminal 21. The second end portion 22b is an end portion on the opposite side of the first end portion 22a.

The first branching line 23a is electrically connected between the second end portion 22b and the first circuit block 40. The second branching line 23b is electrically connected between the second end portion 22b and the second circuit block 50. The first branching line 23a and the second branching line 23b form a plurality of branching lines.

The reverse-current preventing element 27 is provided on the first branching line 23a. The other reverse-current preventing element 28 is provided on the second branching line 23b. The reverse-current preventing elements 27 and 28 prevent a reverse current from flowing. In other words, the reverse-current preventing elements 27 and 28 cause a current to flow in a forward direction, and prevent a current from flowing in a reverse direction. In the following, a portion into which the current in the forward direction flows is referred to as “input portion of the reverse-current preventing element 27 or 28,” and a portion from which the current in the forward direction flows out is referred to as “output portion of the reverse-current preventing element 27 or 28.”

The input portion of the reverse-current preventing element 27 is electrically connected to the second end portion 22b, and the output portion of the reverse-current preventing element 27 is electrically connected to the first circuit block 40. The input portion of the other reverse-current preventing element 28 is electrically connected to the second end portion 22b, and the output portion of the other reverse-current preventing element 28 is electrically connected to the second circuit block 50. As each of the reverse-current preventing elements 27 and 28, for example, a diode is used. In this case, the input portion of each of the reverse-current preventing elements 27 and 28 is an anode, and the output portion of each of the reverse-current preventing elements 27 and 28 is a cathode.

The first circuit block 40 includes the first input capacitor 41, the first internal power supply 42, and the first load 43. The first input capacitor 41 is connected between the first branching line 23a and the first ground GND1. That is, the first input capacitor 41 is electrically connected to the output portion of the reverse-current preventing element 27. The first internal power supply 42 and the first load 43 are connected in series to each other between the first branching line 23a and the first ground GND1. That is, the first input capacitor 41 is connected in parallel to the first internal power supply 42 and the first load 43.

An input portion of the first load 43 is connected to an output portion of the first internal power supply 42. An output portion of the first load 43 is connected to the first ground GND1.

The first internal power supply 42 generates the first output voltage Vout1 through use of power supplied from the first external power supply 31. The first load current IL1 flows through the first circuit block 40.

The second circuit block 50 includes the second input capacitor 51, the second internal power supply 52, and the second load 53. The second input capacitor 51 is connected between the second branching line 23b and the first ground GND1. That is, the second input capacitor 51 is electrically connected to the output portion of the other reverse-current preventing element 28. The second internal power supply 52 and the second load 53 are connected in series to each other between the second branching line 23b and the first ground GND1. That is, the second input capacitor 51 is connected in parallel to the second internal power supply 52 and the second load 53.

The input portion of the second load 53 is connected to the output portion of the second internal power supply 52. The output portion of the second load 53 is connected to the first ground GND1.

The second internal power supply 52 generates the second output voltage Vout2 through use of power supplied from the first external power supply 31. The second load current IL2 flows through the second circuit block 50.

When the output voltage of the first external power supply 31 is momentarily reduced, the reverse-current preventing element 27 prevents a sneak current from flowing from the first input capacitor 41 to the second internal power supply 52. Further, in this case, the other reverse-current preventing element 28 prevents a sneak current from flowing from the second input capacitor 51 to the first internal power supply 42.

When the output voltage of the first external power supply 31 is momentarily reduced, the charges of the first input capacitor 41 are discharged to the first ground GND1 via the first load 43 due to the function of the reverse-current preventing element 27. When the output voltage of the first external power supply 31 is momentarily reduced, the charges of the second input capacitor 51 are discharged to the first ground GND1 via the second load 53 due to the function of the other reverse-current preventing element 28.

As a result, when the output voltage of the first external power supply 31 is momentarily reduced, a current interrupted by the reverse-current preventing element 27 is prevented from flowing from the first input capacitor 41 to the second internal power supply 52 as a sneak current. Accordingly, the discharge via the first load 43 becomes dominant in the degree of influence to the discharge speed of the first input capacitor 41.

Accordingly, an amount of charges required for maintaining the operating voltage of the first internal power supply 42 when the output voltage of the first external power supply 31 is momentarily reduced can be reduced. Thus, a capacitor having a smaller electrostatic capacitance can be used as the first input capacitor 41.

As described above, the electronic control device 10 according to the third embodiment includes the plurality of circuit blocks and the power supply input circuit 20. The power supply input circuit 20 includes the power supply input terminal 21, the power supply input line 22, the plurality of first branching lines 23a and 23b, and the plurality of reverse-current preventing elements 27 and 28. The power supply input terminal 21 is connected to the first external power supply 31. The power supply input line 22 includes the first end portion 22a and the second end portion 22b. The first end portion 22a is connected to the power supply input terminal 21. The second end portion 22b is an end portion on the opposite side of the first end portion 22a. The plurality of branching lines 23a and 23b are connected between the second end portion 22b and each of the plurality of circuit blocks. The plurality of reverse-current preventing elements 27 and 28 are provided on the plurality of branching lines 23a and 23b, respectively, and prevent a reverse current from flowing.

With this configuration, an increase in size of the electronic control device 10 can be suppressed.

In the third embodiment, the electronic control device 10 includes two circuit blocks, but the number of the circuit blocks may be three or more. In this case, it suffices that the reverse-current preventing element is provided on each of the branching lines corresponding to the respective circuit blocks.

Further, in the first to third embodiments, a diode is used as the reverse-current preventing element, but, as the reverse-current preventing element, for example, a fast recovery diode, a Schottky barrier diode, a thyristor, and back-to-back metal-oxide-semiconductor field effect transistors (MOSFETs) may be used.

Further, in the first to third embodiments, all of the input capacitors and the loads in the plurality of circuit blocks are connected to the first ground GND1, but any of the input capacitors and any of the loads may be connected to the second ground GND2.

Further, in the first to third embodiments, the second external power supply 32 is provided, but the second external power supply 32 is not required to be provided.

Further, in the first to third embodiments, the electronic control device 10 is the on-vehicle electronic control device, but the electronic control device 10 is not required to be an on-vehicle device as long as the electronic control device 10 uses an external power supply. Further, the external power supply to be used is not limited to the on-vehicle battery.

What is claimed is:

1. An electronic control device, comprising:
a plurality of circuit blocks; and
a power supply input circuit configured to supply power supplied from an external power supply to the plurality of circuit blocks,
wherein the plurality of circuit blocks include a first-type block and a second-type block, and
wherein the power supply input circuit includes:
a power supply input terminal to be connected to the external power supply;
a power supply input line including a first end portion connected to the power supply input terminal, and a second end portion being an end portion on an opposite side of the first end portion;
a plurality of branching lines connected between the second end portion and each of the plurality of circuit blocks;
a first reverse-current preventing element which is provided on the power supply input line, and is configured to prevent a reverse current from flowing; and
a second reverse-current preventing element which is provided on one of the plurality of branching lines that is connected to the first-type block, and is configured to prevent a reverse current from flowing.

2. The electronic control device according to claim 1,
wherein the first-type block includes a first-type internal power supply configured to generate a first output voltage through use of the power supplied from the external power supply,
wherein the second-type block includes a second-type internal power supply configured to generate a second output voltage through use of the power supplied from the external power supply, and
wherein a lower limit value of an input voltage that allows the second-type internal power supply to normally generate the second output voltage is lower than a lower limit value of an input voltage that allows the first-type internal power supply to normally generate the first output voltage.

3. The electronic control device according to claim 1, wherein a second load current being a load current flowing through the second-type block is larger than a first load current being the load current flowing through the first-type block.

4. The electronic control device according to claim 1,
wherein the first-type block includes a first-type internal power supply configured to generate an output voltage through use of the power supplied from the external power supply, and a load connected to an output portion of the first-type internal power supply, and
wherein the second-type block includes a load, and is free of an internal power supply.

5. A power supply input circuit, comprising:
a power supply input terminal to be connected to an external power supply;
a power supply input line including a first end portion connected to the power supply input terminal, and a second end portion being an end portion on an opposite side of the first end portion;
a plurality of branching lines connected between the second end portion and each of a plurality of circuit blocks;
a first reverse-current preventing element which is provided on the power supply input line, and is configured to prevent a reverse current from flowing; and
at least one second reverse-current preventing element which is provided on a corresponding one of the plurality of branching lines that is connected to a first-type block being a part of the plurality of circuit blocks, and is configured to prevent a reverse current from flowing.

6. An electronic control device, comprising:
a plurality of circuit blocks; and
a power supply input circuit configured to supply power supplied from an external power supply to the plurality of circuit blocks,
wherein the power supply input circuit includes:
a power supply input terminal to be connected to the external power supply;
a power supply input line including a first end portion connected to the power supply input terminal, and a second end portion being an end portion on an opposite side of the first end portion;
a plurality of branching lines connected between the second end portion and each of the plurality of circuit blocks; and
a plurality of reverse-current preventing elements which are provided on the plurality of branching lines, respectively, and are configured to prevent a reverse current from flowing.
